(19) United States
(12) Patent Application Publication
(10) Pub. No.: US 2020/0014287 A1
(43) Pub. Date: Jan. 9, 2020

(54) A ROTOR AND PRODUCTION OF A ROTOR OF A ROTATING ELECTRICAL MACHINE

(71) Applicant: Siemens Aktiengesellschaft, 80333 München (DE)

(72) Inventors: Roland Bittner, Ansbach (DE); MARKUS HÖSLE, Erlangen (DE)

(73) Assignee: Siemens Aktiengesellschaft, 80333 München (DE)

(21) Appl. No.: 16/337,817

(22) PCT Filed: Sep. 25, 2017
(86) PCT No.: PCT/EP2017/074188

§ 371 Date: Mar. 28, 2019

(30) Foreign Application Priority Data
Sep. 30, 2016 (EP) 16191733.1

(51) Int. Cl. H02K 15/00; H02K 15/10; H02K 3/16; H02K 3/24; H02K 3/34; H02K 3/487; H02K 17/18

(52) U.S. Cl. CPC H02K 15/0012; H02K 15/105; H02K 3/16; H02K 17/185; H02K 3/345; H02K 3/487; H02K 3/24

(57) ABSTRACT

The invention relates to a method for producing a rotor (14) for a rotating electrical machine (10) in which at least one rotor winding (20) is introduced into a rotor laminated core (16) of the rotor (14) in an electrically insulated manner, wherein the rotor winding (20) is designed as an electrically insulated cage and/or as a damper loop at least partially by means of an additive production method in the rotor laminated core (16), wherein an electrical insulation layer (46) is formed at the same time as the rotor winding (20) is formed between an electrical conductor (22) of the rotor winding (20) and the rotor laminated core (16) and/or between adjacent conductors (22) of the rotor winding (20).

The invention relates to a method for production of a rotor for a rotating electrical machine, in at which at least one rotor winding is inserted electrically insulated into a rotor laminated core of the rotor. The invention further relates to a rotor for a rotating electrical machine, with a rotor laminated core, at least one rotor winding, which is inserted electrically insulated into the rotor laminated core and is embodied as an electrically insulated cage and/or as a damper loop, and a layer of electrical insulation formed between at least one electrical conductor of the rotor winding and the rotor laminated core and/or between adjacently arranged electrical conductors of the rotor winding. Finally the invention also relates to a rotating electrical machine with an armature and a rotor rotatably supported in an opening of the armature.

Generic electrical machines as well as rotors for said machines are known according to the prior art, so that there is no need for separate documentary evidence thereof. In a rotating electrical machine an armature is generally provided as a stator, which usually provides an essentially circular opening for accepting an armature embodied as a rotor. In the opening the rotor is arranged rotatably supported about an axis of rotation of the rotor, wherein an air gap is formed between the rotor and the stator.

The rotating electrical machine is a device which, when operating as a motor, converts electrical energy into mechanical energy, especially movement energy, and/or, when operating as a generator, converts mechanical energy into electrical energy. As a rule the movement involved is a rotational movement, which is carried out by the rotor. The stator—by contrast with the rotor—is arranged in a rotationally fixed manner, meaning that the rotational movement involves a rotational movement of the rotor in relation to the stator.

The stator and the rotor are linked by a magnetic flux, through which, during operation as a motor, the power effect, namely the torque, is created, which drives the rotation of the rotor hi relation to the stator, hi generator operation the mechanical energy supplied to the rotor in the form of a rotation is converted into electrical energy. For this purpose the stator and the rotor each have a winding through which an electric current flows.

Rotating electrical machines of the generic kind are polyphase machines for example, which are connected to a multi-phase, especially three-phase, electrical alternating current network, such as for example asynchronous machines, synchronous machines, synchronous machines with a damper cage or the like, or also direct current machines such as shunt-wound machines or series-wound machines or the like.

A particular rotating electrical machine is the asynchronous machine, in which the rotor runs ahead in generator mode or trails behind in motor mode in a rotating magnetic field of the stator. The asynchronous machine has a passive rotor, which can be either short-circuited permanently as a kind of short circuit rotor or cage rotor or also occasionally, for example with a slip ring rotor. During use in generator mode the rotor of the asynchronous machine can also be excited with a deviating frequency, for example with a double-fed induction machine or the like. Asynchronous machines able to be operated with a single phase are for example the capacitor motor, the shaded-pole motor the starting motor or the like.

Nowadays the asynchronous machine is one of the most widely used rotating electrical machines. An advantage of asynchronous machines compared to other rotating electrical machines is that a commutation by means of commutator and brushes can be avoided. Nevertheless the operation of the asynchronous machine produces an unwanted system perturbation, and does so in relation to harmonics, which are caused inter alia by the network-side electrical current brought about.

Usually the asynchronous machine essentially has as its main components the stator and the rotor. In the windings of the rotor and the stator electrical currents are essentially conducted in an axial direction, i.e. in parallel to the axis of rotation of the rotor on the air gap side. For this purpose both the stator and also as a rule the rotor as well each have correspondingly embodied windings, namely on the stator side a stator winding and on the rotor side a rotor winding. The rotor winding can comprise one or more wire windings, one or more pre-formed coils, one or more cages embodied from electrical conductors, in particular bars, combinations hereof or the like. For the desired conveyance of the magnetic field provided by the windings, laminated cores are provided both on the stator side and on the rotor side, and this is done by the stator laminated core on the stator side and the rotor laminated core on the rotor side. Usually the laminated cores are designed with laminations in the axial direction according to the axis of rotation, in order to reduce undesired effects because of eddy currents and/or the like for example, or even to avoid them entirely.

With a short circuit or cage rotor the winding is short circuited within the rotor as a rule. It can for example have electrically conductive bar windings or the like. With a bar winding axial ends of the electrically conductive bars are short circuited at the axial ends of the rotor for example by means of a short-circuit ring or the like. The method of operation of the asynchronous machine is based on a rotating field generated by the stator winding, which is essentially aligned axially in the air gap between the stator and the rotor. In order to be able to achieve a force effect on the rotor that is as even as possible, an air gap field running sinusoidally would be desirable. This would have to be provided by the stator winding. At the same time a favorable effect in respect of system perturbations, in particular the harmonics, could be achieved by this.

With the asynchronous machines currently able to be realized however narrow limits are set in this respect. Through the previously usual production methods, i.e. the arrangement of electrically conductive bars in slots of the rotor laminated core opening radially outwards, although a certain influence can be achieved by the number of bars, the options for influencing are limited.

Over and above this, attempts have already been made to introduce additional electrically conductive bars within the laminated core. However this method has proved to be extraordinarily complex in production terms, so that this technology has barely been able to become established to date.

Finally there have also been attempts, through pitching factors of a pitched winding system of the stator, to reduce the harmonics, in order to be able to adapt the air gap field to a sinus shape. Such a winding system however needs a high outlay in copper because of the end face-side circuit arrangement, which does not contribute to the drive effect of the synchronous machine and thus in some cases greatly reduces the efficiency of the asynchronous machine. An improvement in this regard can be achieved with concentrated windings, for example toothed coils, however the situation in relation to the harmonics of the air gap field is made worse by this.

Therefore the underlying object of the invention is to improve a production method for a rotor and also a rotating electrical machine. In particular a rotor for the rotating electrical machine with an improved effect in relation to system perturbations, in particular harmonics, and/or a drive effect is to be achieved.

As a solution, a method, a rotor and &so a rotating electrical machine as claimed in the independent claims are proposed with the invention.

Further advantageous embodiments emerge with reference to the features of the dependent claims.

With regard to a generic method it is proposed in particular with the invention that the rotor winding is formed by means of an additive production method in the rotor laminated core, wherein at the same time as the formation of the rotor winding, a layer of electrical insulation is formed between an electrical conductor of the rotor winding and the laminated core and/or between adjacently arranged electrical conductors of the rotor winding.

With regard to a generic rotor it is proposed in particular in accordance with the invention that a material of at least one of the electrical conductors, in particular transverse to a direction of current conveyance specified by the at least one of the electrical conductors, and/or a cross-sectional surface in the longitudinal extent direction of the at least one of the electrical conductors is changed.

With regard to a generic rotor it is proposed in particular in accordance with a second aspect of the invention that the rotor winding provides at least two cages electrically insulated from one another, wherein sections conveyed in the rotor laminated core of the respective electrical conductors assigned to the different cages are arranged such that, in their longitudinal extent direction they have at least two spacings different from one another.

With regard to a generic rotating electrical machine it is proposed in particular that the rotor is embodied in accordance with the invention.

With the invention it is possible for the first time to realize almost any given embodiment of the rotor winding, in particular to form a number of rotor windings in a simple manner, which preferably can also be formed electrically insulated from one another. This explicitly enables influence to be exerted on the magnetic field in the air gap of the rotating electrical machine, so that, by suitable arrangement of conductors for example, a good approximation to a sinusoidal shape of the air gap field can be achieved. The additive production method namely makes it possible, in a simple manner, to form even complex conductor structures as a rotor winding. Thus the conductors of the rotor winding no longer absolutely need to be positioned elusively in the area of the surface of the rotor, but, what is more, conductors can also be provided that are arranged recessed in the laminated core, in particular are also form within the laminated core and surrounded by it. This opens up the possibility of providing almost any given winding structure, which allows adapted magnetic fields to be used for the very widest range of operating conditions, Thus not only can the level of efficiency be improved, but also the circumferential magnetic field embodied in the air gap can be better adapted to the sine shape, in order to reduce or even to avoid entirely system perturbations such as harmonics for example with regard to the supply current.

In this case the laminated core can for example be provided accordingly before the formation of the electrical conductors of the laminated core, so that only the rotor winding need still to be inserted into the rotor laminated core by means of the additive production method. The rotor winding can preferably be inserted here in the axial direction of the axis of rotation, wherein for example conductors of the stator winding are embodied in layers in their axial extent and at the same time the rotor laminated core is completed layer-by-layer by adding respective individual laminations. In this way the electrical conductors of the rotor winding are permanently ready for access for the additive production method, for example for a print head or the like, so that a reliable realization of the production of the rotor can be achieved. At the same time the invention makes it possible not only to realize the conductors of the rotor winding, but also a suitable electrical insulation to adjacent electrical conductors of the rotor winding or other components, for example of the laminated core or the like. No further working steps are thus required in order to be able to provide a fully functional rotor for the mutating electrical machine.

The additive production method also enables the rotor winding in particular to be embodied as at leas: two cages electrically insulated from one another. In this way for example a number of cages insulated electrically from one another or at least damper loops can be embodied within the rotor, which form the rotor winding, which damp out specific parts of the respective harmonics of the air gap field or also—depending on operating state—even make it possible for the harmonics to be able to be used for a machine function according to specification. Moreover a single-cage rotor can naturally also be produced, which merely has a single cage as its rotor winding.

The use of the additive production method opens up a greater range of forms for the embodiment of the rotor winding, in particular of the rotor as a whole. This means that the production of the rotor is no longer restricted, for example because it no longer has to be considered whether, with a hybrid rotor for example, an electrical conductor of the rotor winding is inserted in the form of a bar made of copper into a slot of the rotor laminated core or not. Also it no longer needs to be considered whether, when casting a cage from aluminum, all slots are also cast with aluminum. In particular a slot shape does not have to be changed any longer for improving the casting. Also different melting points, because of the use of copper in conjunction with aluminum in the hybrid rotor, for example with copper bars and cast aluminum, are essentially insignificant through the use of the additive production method.

Different methods can be used as the additive production method, for example a sinter or powder print method, a printing with extruded building materials, a stereo lithography and/or the like. In particular a 3D printing with powder (3DB), selective laser sintering (SLS), selective laser melting (SLM) or the like are suitable as an additive production method. These additive production methods are especially suitable for the production of the rotor. In relation to the production method the reader is referred in addition to 3D printing by Petra Fastermann, published by Springer Viehweg, 2014.

Individual or all electrical conductors of at least one cage can be at a different distance from the axis of rotation over their axial alignment for example with regard to how far they extend towards the floor of a slot. It is also possible for individual electrical conductors or also for all electrical conductors of at least one cage, for example with regard to how far they extend towards the cylindrical outer side of the rotor, to be at a different distance from the latter.

It is further proposed that at least one of the electrical conductors is embodied by means of the additive production method partly transverse to a direction of current conveyance determined by the at least on electrical conductor. In this way the embodiment of the at least one electrical conductor for example, at least when it is arranged for example essentially parallel to a longitudinal axis of the rotor, can be in the direction of a radial extent of the rotor. This allows the at least one electrical conductor, in particular in respect of its geometry, to be able to be flexibly embodied in the widest diversity of ways to enable the widest variety of requirements to be realized. The requirements can be determined by the magnetic field, system perturbations, level of efficiency and/or the like for example.

It is further proposed that the at least one of the electrical conductors, at least transverse to the direction of current conveyance determined by the at least one of the electrical conductors, has a layer structure with at least two layers, which each feature materials differing from one another. This allows the at least one electrical conductor to be able to be embodied in a simple manner in almost any way in respect of technical requirements. The layer structure enables particular electrical characteristics to be achieved where necessary. Inter alia the rotor winding, in particular the electrical conductors of the rotor winding, can also be provided in a type of sandwich construction. A layering provided by this can be provided radially and/or tangentially for example. Layers of the sandwich construction can be short-circuited via the respective short-circuit ring.

The at least two layers feature different materials from one another, wherein the materials should be sufficiently suitable however for conveying electrical current however. Each of the materials can be formed by a metal, an alloy, especially of metals, but also by a composite material, an electrically conductive material and/or the like. In this way for example one of the at least two layers can feature layers of copper and the other of the at least two layers can feature layers of aluminum. Distinct layer boundaries do not have to be present. A gradual transition can namely be provided, at least in the area of a layer boundary. In this way there can be provision, in the transition area, for a proportion of a first material of a first layer to gradually reduce in the direction of an adjoining second layer, while a proportion of a second material of the second layer gradually increases accordingly in the transition area, The transition can also extend over the totality of the adjoining layers. Moreover a separate third material, which is different from the first and the second material, can also be provided in the transition area. The third material can likewise be an electrically conductive substance,

Advantageously a layer of electrical insulation can be embodied between two adjacently embodied layers. The layers do not then need to have the same electrical potential applied to them. To this extent the third material can thus also be an insulation material. Especially advantageously the electrical conductors formed by layers insulated from one another can be assigned to different cages of cages electrically insulated from one another.

Naturally there can also be provision for one of the layers to be formed completely from an insulating material. The insulating material can be formed by an oxide of a metal, an electrically insulating plastic and/or composite material, combinations hereof and/or the like.

In accordance with an advantageous development it is proposed that the layer of electrical insulation be embodied by deposition of an electrically insulating ceramic material. The use of an electrically insulating ceramic material is particularly suitable for use in the aforesaid additive production method, since the layer of electrical insulation can be produced with the same technology with which the electrical conductors can also be embodied. Thus only the materials used have to be selected and supplied adapted accordingly for this, in order to form the desired structure.

Basically the layer of electrical insulation can also naturally be embodied at least partly by deposition of a plastic, so that the layer of electrical insulation is embodied by a suitable plastic. In this case however there would have to be provision for a corresponding additional effort with regard to the additive production method, which additionally takes into account the processing of plastic. The ceramic material can be an electrically insulating oxide, for example aluminum oxide, silicon oxide, combinations hereof or the like for example.

In accordance with a development it is proposed that the layer of electrical insulation be embodied by a surface of the conductor of the rotor winding reacting chemically at least partly with a further substance in order to embody the layer of electrical insulation at least partly. This can be achieved for example by the surface of the electrical conductor to be insulated having a suitable chemical substance applied to it, so that a corresponding insulation layer is formed by a chemical reaction on the surface of the conductor. In this way it is possible for example, during the formation of an electrical conductor made of aluminum, to provide its surface to be insulated in relation to adjacent electrical conductors or the laminated core with a suitably formed aluminum oxide layer, by supplying oxygen during the embodiment process at the points at which the electrical insulation is to be formed, so that by the reaction with the aluminum of the electrical conductor, an aluminum oxide layer is formed, which provides an electrical insulation. Other chemical pairings can also be provided in order to provide a suitable electrical insulation. Depending on dielectric strength, provision can be made for a corresponding exposure time for the chemical reaction. Moreover, depending on the dielectric strength to be provided, there can also be provision for an appropriate choice of the suitable substances.

It proves especially advantageous for the further substance to be an oxidation medium, in particular oxygen, which forms the layer of electrical insulation by chemical reaction with a material of the electrical conductor. The oxidation means can be supplied to the desired location to be insulated by a suitable supply unit. Preferably the oxidation medium is fluid, in particular gaseous. It can be supplied by means of a suitable nozzle to the location to be insulated. There can also be provision for the oxidation medium to comprise an acid or the like.

A further embodiment of the invention makes provision for the rotor laminated core to be embodied jointly with the rotor winding. The rotor laminated core can likewise be formed in layers. In this case there can be provision for the layers of the laminated core to be insulated from one another to be able to be formed as very thin layers, in order to further reduce losses during operation according to specification. It is namely possible through the additive production method also to reduce the selected lamination thicknesses for the rotor laminations of the rotor laminated core. The previously usual lamination thicknesses represent compromise values as a rule, which make possible a useful suppression of eddy current formation during operation according to specification with a reasonable production outlay. The additive production method enables the lamination thickness to now be selected very much thinner, because the individual laminations do not themselves need to be produced in a separate production method. The efficiency of the rotating machine can be further improved by this. In this case there can also be provision, with the insulation of the individual layers of the rotor laminated core, for these to be electrically insulated from one another by formation of a ceramic insulation layer, in order effectively to suppress the formation of eddy currents. For this a method can be used as has already been explained in relation to the insulation of the electrical conductor of the rotor winding.

Through the use of the additive production method it is thus possible not just to construct a rotor from a single type of sheet metal for the laminate core, but from a suitably selected different selection of types of sheet metal. Thus each sheet of metal can differ from another and/or from the next, If the rotor has beveled conductors at least in one cage for example and if the rotor additionally has cooling channels, then these cooling channels can also run in parallel to its axis and do not need to be beveled.

Especially advantageously the rotor winding is embodied at least partly as an electrically insulated cage and/or as a damping loop. This allows a short circuit rotor for a rotating electrical machine to be realized in a simple manner. This enables the rotor winding to be produced as a homogeneous one-piece component of the rotor. No additional electrical connections need to be provided, so that the reliability and durability of the rotor can be improved. There can be provision for the cage to be embodied electrically insulated only in the area of the laminated core. A short circuit ring of the cage on the other hand can be embodied without an electrical insulation, in particular when it projects axially from the laminated core. Naturally there can also be provision for the cage to be embodied in its entirety without an electrical insulation,

A cage of the rotor winding basically has conductors running essentially axially, which can be aligned straight and/or also beveled. Depending on their construction, the electrical conductors can be electrically contacted at the opposite end-face sides of the rotor and/or if necessary also intermediately by means of short circuit rings. The rotors can thus also be embodied as staggered rotors or double staggered rotors, if the rotor has a plurality of cages, for example two, three or even more cages, which are preferably electrically insulated from one another and if necessary are also electrically insulated from the laminated core, one cage can be embodied staggered for example and a further cage also simply angled.

The electrical conductors of the cages of the rotor winding can be arranged in one another and/or radially above one another and/or, viewed in the circumferential direction, next to one another in the same and/or different slots of the rotor. The slots can be formed by a concatenation of punched sheets of the rotor laminated core or also by the additive production method.

With a number of cages the respective short circuit rings can be arranged in one another and/or also radially below one another and or axially behind one another.

With double-cage rotors, double-slot multiple cage rotors, double-slot rotors, high-slot rotors, high-bar rotors and/or the like the conductors can have a course that runs essentially straight. Through the invention, in particular the additive production method, it is however possible to realize said conductors bent, curved or with other courses. There can even be provision for a change in the cross section in a longitudinal extent of the electrical conductor.

Moreover there can be provision for at least one short circuit ring to be embodied at an axial end of the rotor, on which a cooling unit especially projecting beyond an axial extent of the rotor laminated core is formed. Preferably the cooling unit is formed in one piece with the short circuit ring. Thus separate units for the purposes of cooling do not have to be provided. The cooling unit can be formed for example by the short circuit ring having corresponding projections on the end-face side on at least one of the axial ends of the rotor, which are formed as additions by the additive production method in one step and with which a cooling function for the rotor can be achieved. The projections can have a scoop shape or the like. Moreover there can naturally be provision for corresponding channels for a cooling fluid to be formed as an addition by means of the additive production method in the rotor winding and/or in the rotor laminated core. By means of the additive production method such cooling channels can namely be provided in a suitable manner and at especially preferred places, at which they would not be able to be realized with conventional production methods. In particular very filigree cooling structures can naturally be realized, which allow the rotor to be able to be cooled in an improved way in accordance with the generation of heat in operation as per specifications, so that the rotor, when operating according to specifications reaches a temperature level that is as even as possible for example. Preferably there can be provision for the cooling channels to be formed for the supply of a fluid able to be supplied to the rotor externally.

A further embodiment of the invention makes provision for the electrical conductor of the rotor winding to be formed in a slot of the laminated core open to the outside and for the slot to be closed off by means of an, especially magnetic, slot closure, preferably produced by means of the additive production method. This enables an improved formation of the magnetic field for the air gap field to be achieved, in order to reduce harmonics being formed. The slot closure can be formed at the same time as the electrical conductor. For example open slots of the rotor can be closed by magnetic slot closures, which can lead to fewer fluctuations of the magnetic conductance, whereby fewer harmonics and fewer losses, for example sawtooth pulsation losses, in particular when a toothed winding is used, can be achieved. The slot closure can also be produced by means of the additive production method. Preferably the slot closure can also be embodied flush with the cylindrical surface of the rotor, whereby noise generated when the rotating electrical machine is operating according to specification can be reduced. Damping windings too can be produced additively in this way.

Basically the cage in a cage rotor can be adapted to almost any given number of pole pairs of the stator or can adapt itself to these.

The invention makes it possible to be able to better restrict harmonic field torques to a narrow range of speeds, wherein for example a harmonic wave saddle can run at a very acute angle. The harmonic field torques depend in particular on the number of rotor slots, wherein as a rule they can become stronger with an increasing number of rotor slots.

It is further proposed that the electrical conductor of the rotor winding be arranged in a plane that extends outside an axis of rotation of the rotor. The axis of rotation of the rotor in this embodiment thus does not need to be in the plane in which the electrical conductor of the rotor winding is arranged. This enables the effect with regard to the harmonics and also an effect with regard to any latching on startup of the rotating electrical machine to be reduced or even avoided.

It is further proposed that at least one of the electrical conductors of the rotor winding is embodied in the rotor laminated core such that a predetermined harmonic effect with regard to a magnetic field of the stator of the electrical machine is provided during operation according to specification. This enables the harmonic effect to be adapted in a predeterminable way.

A development makes provision for a dimension of the at least one electrical conductor, in particular transverse to a direction of current conveyance specified by the at least one of the electrical conductors, to be changed. As a rule the direction of current conveyance corresponds to a longitudinal extent of the electrical conductor. This embodiment allows the electrical conductor to be specifically adapted to the current conveyance required. Thus for example a current density distribution transverse to the direction of current conveyance can be included for designing the respective cross-sectional surface. This enables a current displacement or the like to be taken into account. The at least one of the electrical conductors can thus preferably have at least two cross-sectional surfaces different from one another in a longitudinal extent direction of the at least one of the electrical conductors.

In particular it is proposed that a cross-sectional surface of at least one of the electrical conductors is changed in a longitudinal extent direction of the at least one of the electrical conductors during production by means of the additive production method.

Overall rotating electrical machines such as the asynchronous machine, especially with cage rotors, because of the complexity imposed by requirements, can be produced by means of the additive production method. For example this enables additional cages able to be arranged compared to a classical cage rotor to be provided, in order to damp harmonics. Likewise combinations of beveled conductor bars with non-beveled conductor bars can be realized as a rotor winding with the invention. Furthermore, the winding of the stator can also be realized with tooth-wound coils, whereby an automation is possible compared to a star-yoke package arrangement.

When taking account of harmonics a spacing between two electrical conductors of the rotor winding of a cage or of a damping loop is equal to an even number of half waves of the harmonics to be suppressed for example. Possibly a number of outwards and return conductors insulated from one another can also be provided. A spacing can for example amount to ⅘ of a pole division. This enables a number of cages for the rotor winding to be produced within the rotor by the additive production method, &so called 3D technology. In this case the electrical conductor of the rotor winding, for example conductor bars and short circuit rings, the insulation between the electrical conductors and the laminated core and also where necessary between different electrical conductors in a slot of the rotor, and/or the parts conveying the magnetic field, in particular the laminated core, can be produced by the additive production method. Preferably different materials are used. This relates for example to the electrical conductors and the respective short circuit rings, which only arise from the additive production method or printing respectively. A cage can for this reason be produced not only from one but also from a number of electrically conductive materials such as copper, aluminum, silver, alloys of said materials and/or the like. In the choice of the materials different coefficients of expansion can also be taken into account. Stresses can be reduced by a gradual transition from one material to another material.

The respective electrical conductor, in particular conductor bars, can be arranged both for the basic wave and also for any harmonics of the air gap field occurring, separated from one another in the rotor laminated core and/or nested in one another but electrically insulated from one another however. Conductor cross sections of the electrical conductors can depend inter alia on current strengths to be expected or on the starting behavior to be expected, of a skin-effect rotor for example.

The harmonics as a rule have a rotational speed that deviates depending on their harmonic number. The rotational speed is usually just great enough for the magnetic fields, in one period of the mains voltage, to just cover their wavelength. The different rotational speed means that a permanently changing form of the overall field arises. Different cages within the rotor can therefore be optimized for different operating points.

It is further proposed that at least two cages are embodied, of which a first of the cages is embodied for an effect with regard to a basic wave and a second of the cages for an effect with regard to a harmonic. This makes it possible to embody the rotors individually with regard to an interaction with harmonics. In particular there can be provision that, for each harmonic that is to be taken into account, a correspondingly adapted cage is provided. Thus, as well as the second cage, a third, a fourth or an nth cage can also be embodied as well. Preferably each of the cages is then embodied tuned to a different harmonic.

Moreover it is proposed that the electrical conductors for the first cage are produced with a greater conductor cross section than the electrical conductors for the second cage. This takes into account that as a rule a power of the basic wave is far greater than a power of one or more of the harmonics. Frequently the power of the harmonics diminishes with increasing harmonic number. Accordingly conductor cross sections of the cages embodied adapted to the respective harmonics can also be reduced. This not only enables savings in material to be made for the conductors, but, despite the plurality of cages, additional room can also be provided for the conveyance of the magnetic field, for example by the rotor laminated core being additionally embodied in this space or the like. Furthermore carrying out the inventive method makes it possible, unlike the prior art, precisely to provide a plurality of different cages in the rotor in a simple manner. The cages can also have very fine structures, for example filigree structures.

Further features and advantages can be found in the description given below, on the basis of the enclosed figures. In the figures the same reference characters designate the same features and functions. The exemplary embodiments merely serve to explain the invention and are not intended to restrict it.

In the figures:

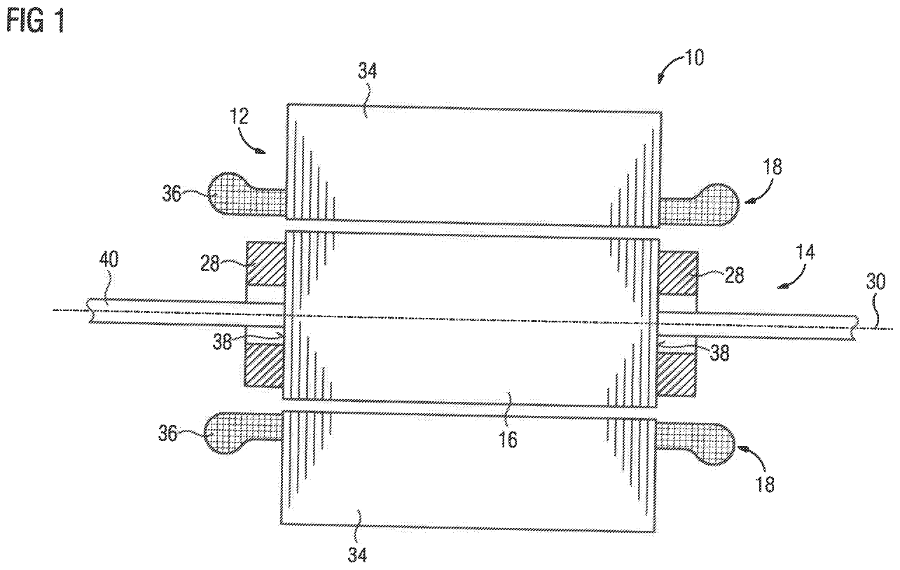

FIG. 1 shows a schematic sectional view of a rotating electrical machine with a cage rotor along an axis of rotation of the rotor;

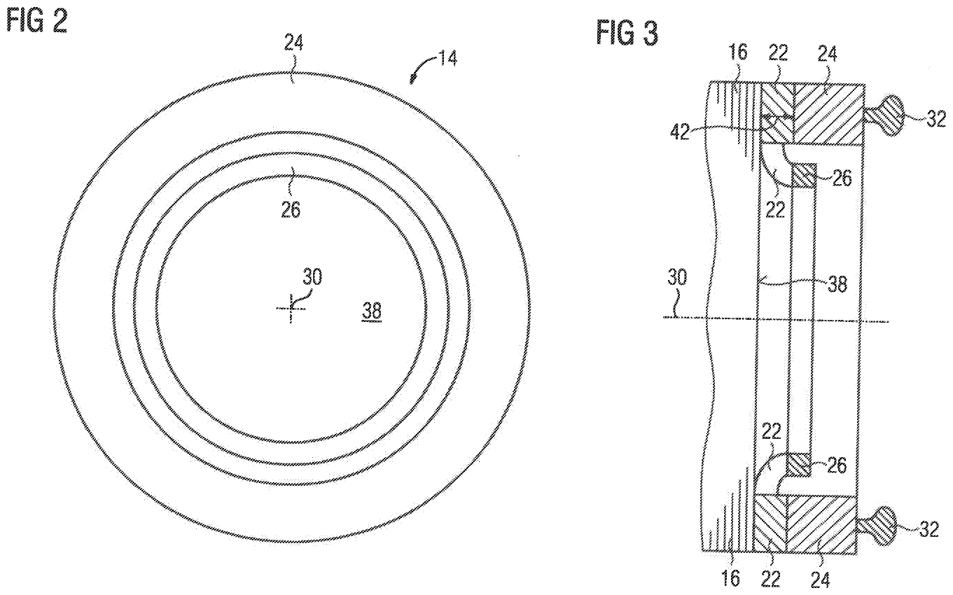

FIG. 2 shows a schematic end-face side view of a first cage rotor in accordance with a first exemplary embodiment with two cages embodied electrically insulated from one another, as well as two short circuit rings arranged radially above one another, produced with a production method of the invention;

FIG. 3 shows a schematic sectional view in the area of an end-face side end of the rotor in accordance with FIG. 2;

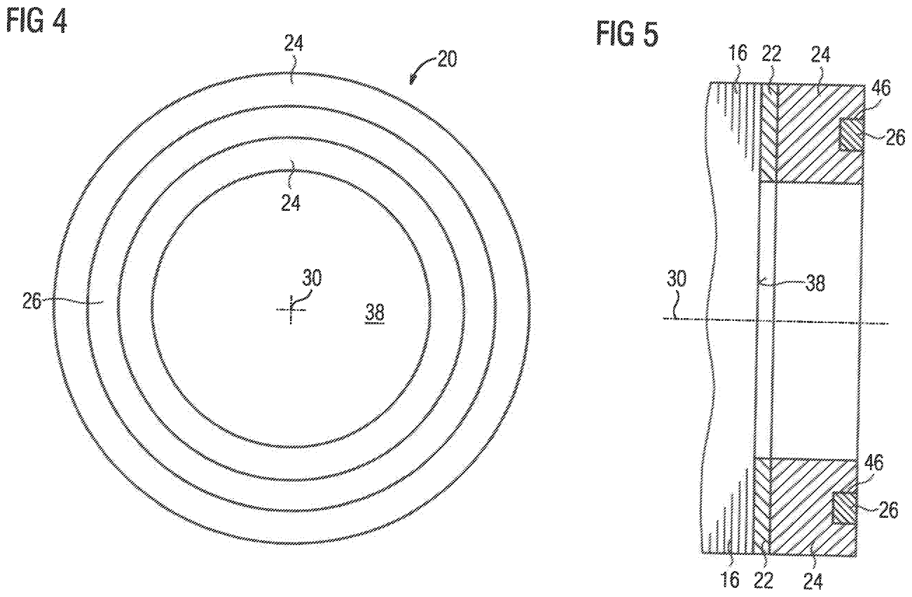

FIG. 4 shows a schematic end-face side view of a second cage rotor with two cages embodied electrically insulated from one another, in accordance with a second exemplary embodiment, wherein the short circuit rings of the cages are arranged in one another, produced with the production method of the invention;

FIG. 5 shows a schematic sectional view in the area of the end-face side end of the rotor in accordance with FIG. 4;

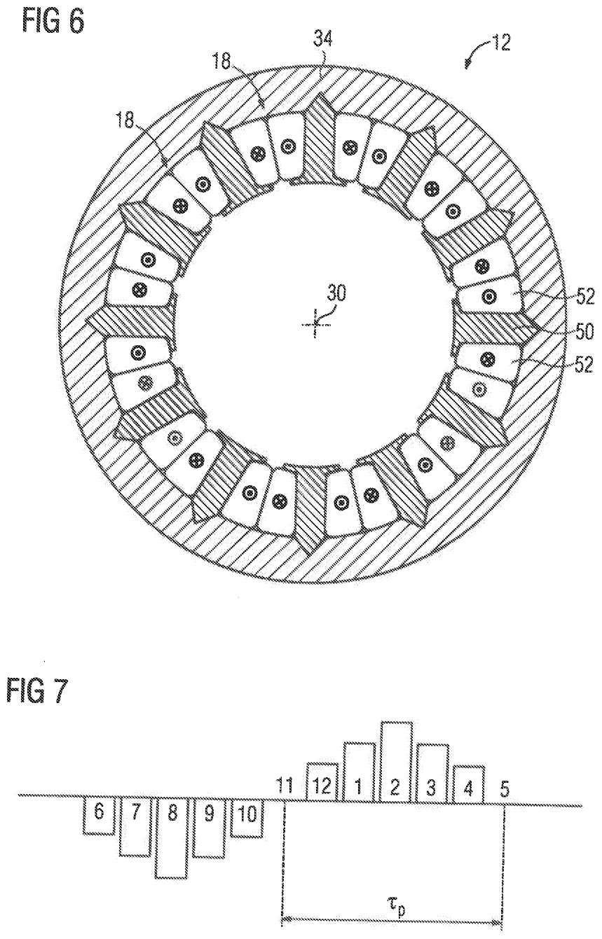

FIG. 6 shows a schematic sectional diagram of a stator for the cage rotor in accordance with one of the preceding exemplary embodiments, wherein the stator has tooth-wound coils in accordance with an embodiment as a two-pole rotating electrical machine;

FIG. 7 shows, in a schematic representation, a diagram by means of which the magnetic field in the air gap distributed over the circumference is represented by bars;

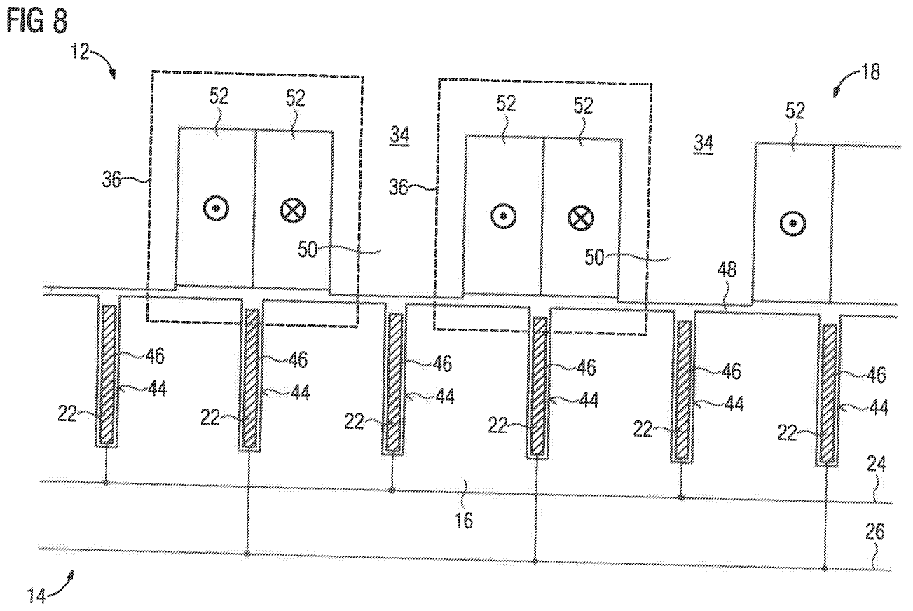

FIG. 8 shows a schematic cross-sectional diagram of a section of the cage rotor in accordance with one of the preceding figures transverse to the axis of rotation of the rotor in the area of an air gap;

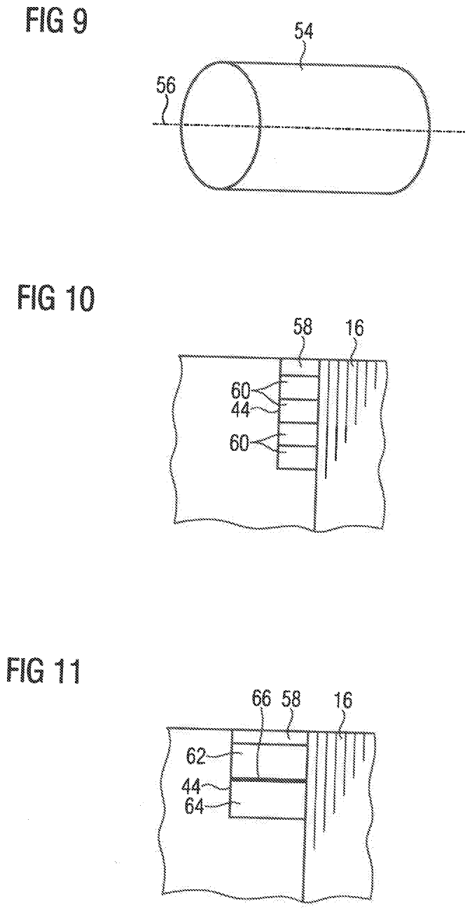

FIG. 9 shows a schematic perspective view of an electrical conductor of the rotor winding of a cage rotor, wherein the electrical conductor is produced in layers radially from the inside outwards by means of the additive production method;

FIG. 10 shows a section of a schematic sectional view in a radially outer area of a slot of a cage rotor, wherein an electrical conductor produced in layers by means of the additive production method is arranged in the slot;

FIG. 11 shows a section of a schematic sectional view in a radially outer area of a slot of a cage rotor, wherein two electrical conductors insulated electrically from one another of different cages of a cage rotor insulated electrically from one another are arranged in the slot.

FIG. 1 shows, in a schematic sectional view, a rotating electrical machine 10, which, in this figure, is embodied as an asynchronous machine for a connection to a three-phase ac voltage network, and which has a stator 12 that is arranged in a rotationally fixed manner. The stator 12 has a stator laminated core 34, in which a stator winding 36 is arranged. In FIG. 1 the winding heads 18 of the stator winding 36 projecting beyond the stator laminated core 34 on the long side are visible. The section in FIG. 1 here is a longitudinal section along an axis of rotation 30 of a rotor 14, which is embodied as a cage rotor.

The rotor 14 is arranged rotatably hi the asynchronous machine 10 and is held rotatably in its position relative to the stator 12 via bearings not shown in any greater detail. The rotor 14 has a rotor laminated core 16, which comprises a rotor winding 20. The rotor winding 20 comprises electrical conductors 22, which are embodied as bars. Short circuit ring units 28 are provided in each case on end-face side ends 38 of the rotor laminated core 16, by means of which the electrical conductors 22 (FIG. 3, 5, 8) are coupled to each other on the end-face side in each case in order to form cages.

The rotor 14 further has a rotor shaft 40, which serves for connection to a rotatable mechanical device. The rotatable mechanical device can have any given function, for example a drive function for an industrial machine, an electrically driven vehicle and/or the like. Moreover the mechanical device can naturally also be an internal combustion engine, a wind turbine and/or the like. Depending on its operating mode, the cage rotor 14 can be supplied with mechanical energy in the form of the rotational movement, so that the asynchronous machine 10 can be operated in a generator mode, or the asynchronous machine 10 can obtain electrical energy via the electrical energy supply network connected to it and can provide a torque in motor mode via the rotor 14 and the rotor shaft 40.

FIG. 2 shows, in a schematic end-face side view, a first embodiment for the asynchronous machine 10 in accordance with FIG. 1, wherein the rotor 14 has two short circuit rings 24, 26 on the end face side in each case, which form the short circuit ring unit 28. The embodiment of the short circuit rings 24, 26 is provided in the same way on both end-face skies of the rotor 14 here. The short circuit rings 24, 26 are arranged radially above one another here, so that the short circuit ring 26 is radially enclosed by the short circuit ring 24. FIG. 3 illustrates this embodiment. It can further be seen that the short circuit ring 24 has axially projecting air scoops 32. An air guidance can be generated with these air scoops 32, which serves to cool the rotor 14 on the end-face side.

It can further be seen from FIG. 3 that the short circuit rings 24, 26 are each connected to the electrical conductor 22. The electrical conductors 22 in this figure are embodied as bar conductors and project axially beyond the end-face side end 38 of the rotor laminated core 16 by a distance a. The short circuit rings 24, 26 are therefore not in direct contact with the rotor laminated core 16. The electrical conductors 22 are each linked electrically-conductively alternately in the circumferential direction to one of the short circuit rings 24, 26. This enables cages electrically insulated from one another to be provided, which, as will be explained below, results in an improved function of the asynchronous machine 10.

FIG. 8 shows schematically, in a sectional cross-sectional diagram, section in the area of the air gap between the stator 12 and the rotor 14. It can be seen from FIG. 8 that the electrical conductors 22 are embodied as bar conductors, The electrical conductors 22 are each connected electrically-conductively alternately to the short circuit ring 24 or to the short circuit ring 26. The electrical conductors 22 are formed in slots 44 of the rotor laminated core 16 that are open radially outwards and essentially extend in the axial direction in parallel to the axis of rotation 30 of the rotor 14. Although there is provision in this figure for the slots to be formed parallel to the axis of rotation 30, there can also be provision however for the slots to be embodied beveled in relation to the axis of rotation 30 of the rotor. The bevel can vary depending on the application for the asynchronous machine.

FIG. 4 now shows, in a view like that shown in FIG. 2, an alternate second embodiment for the short circuit ring unit 28 in accordance with FIG. 1. In the embodiment depicted in FIG. 4 there is provision for a first short circuit ring 24 to accommodate a second short circuit ring 26, so that the second short circuit ring 26 is arranged within the short circuit ring 24. The short circuit rings 24, 26 are electrically insulated from one another by means of a layer of electrical insulation 46. The layer of electrical insulation 46 is formed in this example by an electrically insulating oxide layer. The layer of electrical insulation 46 is produced using an additive production method for producing the rotor 14.

In this way the electrical conductors 22 that are connected to the different short circuit rings 24, 26 will also be electrically insulated from said rings as well and also from one another in relation to the rotor laminated core 16. FIG. 5, in a comparable diagram to FIG. 3, shows a longitudinal section along the axis of rotation 30 of the rotor 14 in the area of the end-face side end 38 of the rotor laminated core 16. In this figure the short circuit ring 26 is radially accessible on the end-face side. In an alternate embodiment the short circuit ring 26 can naturally also be enclosed completely by the material of the short circuit ring 24. A wide range of construction options is opened up here by the additive production method, so that the short circuit ring unit 28 can be adapted to different requirements as required with great precision.

FIG. 6 now shows, in a schematic diagram, an embodiment for the stator 12 of the asynchronous machine 10 in accordance with FIG. 1. It can be seen from FIG. 6 that the stator 12 features the stator laminated core 34, which is equipped with tooth-wound coils 18, which form the stator winding 36. In this figure there is provision that, for embodiment of a two-pole asynchronous machine 10, tooth-wound coils are provided in the circumferential direction, which are connected accordingly to the three-phase electrical energy supply network for forming a rotary field. For this reason the three-phase electrical energy supply network can also be provided by a suitably embodied converter, which is connected for its part to an electrical supply network, an electrical energy store, for example a high-voltage battery, and/or the like.

Each of the tooth-wound coils 18 has a yoke 50, which extends axially in the direction of the axis of rotation 30. A respective tooth is formed by this. The yoke 50 is bordered by electrical conductors 52, through which the same electrical current flows in the opposite direction and, in operation according to specification and a respective coil 18, form the stator winding 36. Through this a magnetic field is generated in a predetermined way along the extent of the yoke 50, which is introduced into an air gap 48 (FIG. 8). The field runs via the air gap 48 into the rotor 14 and here in particular into the rotor laminated core 16, so that the desired electromagnetic interlinkage can be brought about.

It is to be noted that naturally the magnetic field and also the current flowing through the electrical conductors 52 involves variables that change over time.

FIG. 7 shows, in a schematic graphical diagram, a bar diagram, which schematically represents the magnetic field in the area of the air gap 48 created in the circumferential direction by the stator 12 in accordance with FIG. 6. τₚ designates a half rotation phase in relation to the pole division. The individual bars are able to be assigned individual tooth-wound cons 18 in each case. The bars 1 to 12, which are shown in FIG. 7, are naturally likewise variable in accordance with the timing variability. On application of a three-phase alternating line voltage of 50 Hz the bars 1 to 12 vary accordingly over time. Consequently the stator depicted in FIG. 6 provides a corresponding rotating field. The bar diagram thus shows the magnetic field at a fixed point in time.

FIG. 8 now shows a section in the area of the air gap 48 in a cross-sectional diagram transverse to the axis of rotation 30. It can be seen that, on the rotor side, opposite to twelve tooth-wound coils 18 of the stator 12 thirteen trapezoidal bars are provided as electrical conductors 22. The electrical conductors 22—as already explained above—are alternately connected electrically-conductively to one of the short circuit rings 24, 26. Each of the electrical conductors 22 is embodied in a radial longitudinal slot 44 of the rotor laminated core 16 open to the outside. Moreover each of the electrical conductors 22 is arranged electrically insulated from the rotor laminated core 16 by a layer of electrical insulation 46.

In the present invention there is provision for the electrical conductors 22 as well as the layer of electrical insulation 46 to be produced by an additive production method. Initially, in the familiar way, the rotor laminated core 16 is prepared, by individual laminations of the rotor laminated core 16 being produced. This can be done by punching or the like. Then the individual laminations of the rotor laminated core 16 are provided with a layer of electrical insulation not shown in any further detail.

In a next step, by means of selective laser melting (SLS) as an additive production method, a first of the two short circuit ring units 28 is initially produced, by copper being deposited in a predeterminable way, in order to produce the short circuit rings 24, 26. As the method progresses, directly thereafter the electrical conductors 22, here the trapezoidal conductor bars, are embodied step-by-step. As the embodying of the electrical conductors 22 progresses, the individual laminations of the rotor laminated core 16 are inserted and in this way the entire rotor 14 is produced in a continuous working method.

To provide the reliable function, during the embodiment of the electrical conductor 22, its surface is provided with a layer of electrical insulation 46. For this purpose an appropriate electrically insulating ceramic layer is deposited, which in the completed rotor 14 formed is arranged between the electrical conductors 22 and the rotor laminated core 16. The additive production method is continued until such time as the axially opposite short circuit ring unit 28 is completely formed.

Moreover there can be provision for the short circuit rings 24, 26 to be able to be provided on their end-face side with air guidance scoops, like the air scoop 32. This enables a cooling function to be provided for the rotor 14 and also for the entire electrical machine 10 at the same time.

A stray flux is further indicated schematically in FIG. 8 with the reference number 42. This stray flux 42 can be reduced by the second cage winding, which is embodied electrically insulated from the first cage winding, so that overall an improvement in the function of the electrical machine 10 can be achieved.

FIG. 9 shows a schematic perspective view of an electrical conductor 54 of a rotor winding of a cage rotor not shown in any greater detail. In this embodiment the electrical conductor 54 is produced in layers radially from the inside outwards by means of the additive production method. The electrical conductor 54 has a longitudinal axis 56, in which an electrical current is conveyed during operation according to specification. The electrical conductor 54 can be produced at the desired position by individual layers being deposited along the longitudinal axis 56 by means of the additive production method. Such an electrical conductor 54 is shown in FIG. 10. For this reason a blank with a diameter smaller than that required can be provided, which is then built up by means of the additive production method to the desired geometry and size.

FIG. 10 shows a section of a schematic sectional view in a radially outer area of a rotor laminated core 16 of a cage rotor. The area shown comprises a slot 44, in which an electrical conductor 54 produced layer-by-layer by means of the additive production method is arranged. The electrical conductor 54, because of the additive production method, has a layer structure comprising layers 60, which are arranged in above one another in the slot 44 in the radial direction of the cage rotor. The layers 60 in this example directly adjoin one another and in this embodiment are not electrically insulated from one another. Not shown in FIG. 10 however is the fact that the electrical conductor 54 is arranged electrically insulated from the rotor laminated core 16.

The individual layers 60 can for this reason be made of toe same material, in this embodiment however there is provision for the individual layers to have different materials from one another. Thus there is provision for the lowest or radially innermost layer 60 to be formed essentially from copper. The uppermost or radially outermost layer 60 on the other hand is essentially formed from aluminum. Layers 60 lying radially outwards between these two layers have a decreasing copper content and an increasing aluminum content. The materials selected naturally can be varied in almost any given way as required. An inverted layer arrangement is also possible.

The slot 44, after the electrical conductor 54 has been arranged in the slot 44 by means of the additive production method, is closed off radially outwards by means of a slot closure 58. The slot closure 58 in this example is likewise produced by the additive production method. A magnetizable material is provided as the material in this example. As an alternative or in addition however a non-magnetizable material can also be provided, for example a plastic, in particular a composite material, but also combinations hereof and the like.

FIG. 11 shows a section of a schematic sectional view in a radially outer area of a cage rotor. Arranged in a slot 44 of a rotor laminated core 16 are two electrical conductors 62, 64 insulated from one another of different cages of a cage rotor electrically insulated from one another. For this purpose the electrical conductor 64 is first inserted into the slot 44 by means of the additive production method. A layer of electrical insulation 66 is then attached to the electrical conductor 64 by means of the additive production method. Then the electrical conductor 62 is likewise attached to the layer of electrical insulation 66 by means of the additive production method. Finally the slot 44—as already explained for the embodiment depicted in FIG. 10—is closed off by means of a slot closure 58. Here too the electrical insulation of the electrical conductors 62, 64 to the rotor laminated core is not shown in any further detail. For this reason however, it can likewise be produced by means of the additive production method, either before the electrical conductors 62, 64 are inserted into the slot 44, or also during this process. Naturally the individual electrical conductors 62, 64 can also have a layer structure—as already explained with reference to FIG. 10.

In the embodiments depicted in FIGS. 10 and 11, the rotor laminated core 16, and thus also the slot 44, are already present before the insertion of the electrical conductors 54, 62, 64. There can however also be provision for the rotor laminated core 16 and any electrical insulations to be produced by means of the additive production method at the same time as the electrical conductors 54, 62, 64.

The exemplary embodiments described above merely serve to explain the invention and are not restrictive for said invention. In particular features of the exemplary embodiments can naturally be combined with one another in any given way, in order to arrive at further embodiments as per requirements, without departing from the ideas of the invention. In particular different additive production methods can naturally also be combined with one another, in order to arrive at new production methods for the rotor of the rotating electrical machine,

Moreover the invention can naturally also be applied to the stator of the rotating electrical machine.

1.-18. (canceled)

19. A method for producing a rotor for a rotating electrical machine, said method comprising;
forming a rotor winding embodied as an electrically insulated cage and/or as a damper loop in a rotor laminated core through an additive production process; and
forming a layer of electrical insulation between an electrical conductor of the rotor winding and the rotor laminated core and/or between adjacent conductors of the rotor winding, while the rotor winding is formed.

20. The method of claim 19, wherein the rotor winding is embodied as at least two cages electrically insulated from one another.

21. The method of claim 19, wherein the layer of electrical insulation is formed by deposition of an electrically insulating ceramic material.

22. The method of claim 19, wherein the layer of electrical insulation is formed at least in part by a chemical reaction of a surface of the electrical conductor of the rotor winding with a further substance.

23. The method of claim 19, wherein the rotor laminated core is formed together with the rotor winding.

24. The method of claim 19, wherein the layer of electrical insulation is formed at least partly by deposition of a plastic.

25. The method of claim 19, further comprising:
forming a short circuit ring at an axial end of the rotor laminated core; and
forming the short circuit ring with a cooling unit

26. The method of claim 25, wherein the cooling unit extends from the short circuit ring beyond an axial extent of the rotor laminated core.

27. The method of claim 19, further comprising:
forming the electrical conductor of the rotor winding in a radially outwardly open slot of the rotor laminated core and
closing off the slot by a slot closure, in particular a magnetic slot closure, preferably through the additive production process.

28. The method of claim 19, further comprising arranging the electrical conductor of the rotor winding in a plane that extends outside an axis of rotation of the rotor.

29. The method of claim 19, further comprising forming at least one of the electrical conductors of the rotor winding in the rotor laminated core such as to establish a predetermined harmonic effect in relation to a magnetic field of a stator of the electrical machine during operation of the electrical machine.

30. The method of claim 19, further comprising forming at least one of the electrical conductors through the additive production process such as to at least partly extend transversely to a direction of current conveyance determined by the at least one of the electrical conductors.

31. The method of claim 30, further comprising changing a dimension of the at least one of the electrical conductors, in particular transverse to the direction of current conveyance determined by the at least one of the electrical conductors.

32. The method of claim 19, further comprising changing a cross-sectional surface of at least one of the electrical conductors in a longitudinal extent direction of the at least one of the electrical conductors during production by the additive production process.

33. A rotor for a rotating electrical machine, comprising:
a rotor laminated core;
a rotor winding inserted into the rotor laminated core electrically insulated and formed as an electrically insulated cage and/or as a damper loop; and
a layer of electrical insulation formed between an electrical conductor of the rotor winding and the rotor laminated core and/or between adjacent electrical conductors of the rotor winding, with a material of at least one of the electrical conductors being changed, in particular transverse to a direction of current conveyance determined by the at least one of the electrical conductors and/or a cross-sectional surface in a longitudinal extent of the at least one of the electrical conductors.

34. The rotor of claim 33, wherein the at least one of the electrical conductors, at least transverse to direction of current conveyance determined by the at least one of the electrical conductors, has a layer structure with at least two layers made of materials that differ from one another.

35. The rotor of claim 33, wherein the at least one of the electrical conductors, in a longitudinal extent direction of the least one of the electrical conductors, has two cross-sectional surfaces that differ from one another.

36. A rotor for a rotating electrical machine, comprising:
a rotor laminated core;
a rotor winding inserted into the rotor laminated core electrically insulated in the form of at least two different cages that are electrically insulated from one another; and
a layer of electrical insulation formed between an electrical conductor of the rotor winding and the rotor laminated core and/or between adjacent electrical conductors of the rotor winding,
wherein in the rotor laminated core, guided sections of electrical conductors assigned to the cages respectively are arranged such that the guided sections have in a direction of their longitudinal extent at least two different spacings from one another.

37. The rotor of claim 36, wherein the at least one of the electrical conductors, at least transverse to direction of current conveyance determined by the at least one of the electrical conductors, has a layer structure with at least two layers made of materials that differ from one another.

38. The rotor of claim 36, wherein the at least one of the electrical conductors, in a longitudinal extent direction of the least one of the electrical conductors, has two cross-sectional surfaces that differ from one another.

39. A rotating electrical machine, comprising:
a stator; and
a rotor supported rotatably in an opening of the stator, said rotor being configured in one of two ways, a first way in which the rotor comprises a rotor laminated core, a rotor winding inserted into the rotor laminated core electrically insulated and formed as an electrically insulated cage and/or as a damper loop, and a layer of electrical insulation formed between an electrical conductor of the rotor winding and the rotor laminated core and/or between adjacent electrical conductors of the rotor winding, with a material of at least one of the electrical conductors being changed, hi particular transverse to a direction of current conveyance determined by the at least one of the electrical conductors and/or a cross-sectional surface in a longitudinal extent of the at least one of the electrical conductors, a second way in which the rotor comprises a rotor laminated core, a rotor winding inserted into the rotor laminated core electrically insulated hi the form of at least two different cages that are electrically insulated from one another, and a layer of electrical insulation formed between an electrical conductor of the rotor winding and the rotor laminated core and/or between adjacent electrical conductors of the rotor winding, wherein hi the rotor laminated core, guided sections of electrical conductors assigned to the cages respectively are arranged such that the guided sections have in a direction of their longitudinal extent at least two different spacings from one another.
